(19) United States
(12) Patent Application Publication
(10) Pub. No.: US 2022/0354229 A1
(43) Pub. Date: Nov. 10, 2022

(54) A MODULAR LUNCH BOX

(71) Applicant: Mondishkumar Dineshkumar PATEL, Thika (KE)

(72) Inventors: AKSHAY, Delhi (IN); Prayas ROKDE, Bhopal (IN); Darji Bhavarth MUKESHBHAI, Ahemdabad (IN); Saumil BHANDARI, Ahmedabad (IN); Sanandan SUDHIR, Ahmedabad (IN)

(21) Appl. No.: 17/623,184

(22) PCT Filed: Mar. 18, 2020
(86) PCT No.: PCT/IB2020/052457

§ 371 Date: Dec. 27, 2021

(30) Foreign Application Priority Data
Jun. 27, 2019 (IN) 201911025735

(51) Int. Cl. A45C 11/20; F25B 21/04; A47J 36/24

(52) U.S. Cl. CPC A45C 11/20; F25B 21/04; A47J 36/24; F25B 2321/0251; F25B 2700/2104

(57) ABSTRACT

A modular lunch box 100 is disclosed, comprising a base 102 to receive containers 104 to store food articles and having one or both of heating and cooling devices; and a top lid 106 removably received on base to cover and individually seal the containers. A control module 110 is detachably received through a first aperture 112 in top lid 106 such that control module 110 rests against a step portion of containers 104 for operative coupling with heating and cooling devices to control their temperature. Without control module 110, lunch box 100 is usable as a conventional lunch box. Control module 110 includes a wireless communication module to receive user inputs to configure the lunch box for heating and/or cooling of food article at desired times, to desired temperatures. A battery pack positioned over top lid 106, gets coupled to control module 110 to meet power requirement.

### TECHNICAL FIELD

The present disclosure relates to the field of lunch boxes. In particular. It pertains to a modular lunch box that can be used as conventional lunch box as well as a smart lunch box with capability to cool its content to prevent spoilage of the stored food, and to heat it when desired.

### BACKGROUND

Background description includes information that may be useful in understanding the present invention. It is not an admission that any of the information provided herein is prior art or relevant to the presently claimed invention, or that any publication specifically or implicitly referenced is prior art.

A lunch box, also known as tiffin box, is a food carrier that includes a plurality of compartments for securely holding food articles therein. A lunch box is required by users, for example, students, office going persons, teachers, workers, etc. to carry food for consumption when away from home. Depending on ambient temperature, keeping food in the lunch box for long carries the risk of spoilage of food due to growth of microorganisms. In addition, user may prefer to heat its content before consuming.

However, facilities for keeping food cool to prevent growth of microorganisms, and/or to heat the food before consuming is usually not available to most users. To meet the requirement of keeping food hot, insulated lunch boxes are available. However, they can keep food hot only for a limited time. Electrically heated lunch boxes are also available, but they depend on availability of power. Similarly, cold storage boxes are available for storing perishable food items. However, such cold storage boxes require ice to keep the stored food at low temperature. They have their attended drawbacks, such as bulky in size, need to procure ice, and need to attend to left over water as ice melts.

Besides above-mentioned drawbacks, the known lunch boxes with heating and cooling functionality lack customization options like timer setting, temperature setting etc., and the user has to physically attend to the lunch box to ensure heating and/or cooling functions. In addition, the known lunch boxes with heating and cooling functionality are heavy, and the user has to maintain a conventional lunch box for use when he does not need heating and cooling functionality.

There is therefore a need in the art to provide a modular lunch box that has capability to cool and heat its content, can be customized and operated remotely, as well as can be used as conventional lunch box without heating and cooling functionality.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### Objects of the Present Disclosure

Some of the objects of the present disclosure, which at least one embodiment herein satisfies are as listed herein below.

An object of the present disclosure to provide a modular lunch box that can be used both as a conventional lunch box as well as a smart lunch box with heating and cooling functionality.

An object of the present disclosure to provide an improved lunch box that enables selective cooling or heating of stored food.

Another object of the present disclosure to provide a lunch box that does not depend on external power source for heating and cooling functions.

Another object of the present disclosure to provide a lunch box that allows selective cooling or heating of stored food to desired temperatures, at predefined times without physical presence of user.

Another object of the present disclosure to provide a lunch box that can be controlled remotely through a computing device.

Yet another object of the present disclosure to provide a lunch box that can simultaneously provide heating of certain food articles and cooling of other food articles.

It is another object of the present disclosure to provide a lunch box with customizable food containers.

### SUMMARY

Aspects of the present disclosure relate to a modular lunch box that can be used both as a conventional lunch box as well as a smart lunch box with heating and cooling functionality. In an aspect the proposed modular lunch box can be converted to an IoT enabled smart lunch box such that the heating and cooling functions of the lunch box can be remotely controlled through a computing device of its user, thereby eliminating requirement of the user to be physically present.

In an aspect, the modular concept of the proposed lunch box is based on a control module that can be detachably received in an aperture of the lunch box, wherein coupling of the control module with the lunch box enables cooling and heating functions. In another aspect, the control module also converts the lunch box to an IoT enabled smart lunch box such that the heating and cooling functions of the lunch box can be remotely controlled through a computing device of its user.

In an aspect, the disclosed modular lunch box includes a base which defines a housing to receive one or more containers to store a food article. The containers are provided with one or both of a heating device and a cooling device to cool and/or heat their contents. A top lid is removably received on the base to cover and individually seal the containers received within the base to prevent spillage of the food articles stored therein.

In an aspect, the disclosed lunch box further includes a control module, which is detachably received through a first aperture in the top lid. The control module, on being received through the first aperture, rests against the base to establish electrical contacts and gets operatively coupled to the heating devices and the cooling devices of the containers, so that the control module can control temperatures of the containers through the heating devices and the cooling devices.

In an aspect, coupling of the control module with the top lid enables the lunch box to be used as a lunch box having heating and cooling functionality, and wherein when the control module is not coupled with the top lid the lunch box is used as a conventional lunch box.

In an aspect, the control module includes a wireless communication module to receive user defined inputs regarding one or more of activation of the heating devices and the cooling devices pertaining to the one or more containers, time at which the heating devices and the cooling devices are to be activated/deactivated, and temperatures at which the one or more containers are to be maintained.

In an aspect, the disclosed lunch box includes a battery pack adapted to be positioned over the top lid such that when positioned over the top lid, the battery pack gets electrically coupled to the control module to meet power requirement of the lunch box for heating and cooling of food articles stored in the one or more container.

In an aspect, the battery pack includes a second aperture, and the battery pack when positioned over the top lid, gets mechanically coupled to the control module through the second aperture to prevent sideways displacement of the battery pack.

In an aspect, the control module can include a memory; and a processor. The processor may be coupled to the memory, and can execute a plurality of instructions stored in the memory. The processor may also be operatively coupled to the wireless module to receive the one or more user defined inputs and store them in the memory.

In an aspect, the control module may comprises a user interface, which is operatively coupled to the memory to store the one or more user defined inputs provided by the user through the interface.

In an aspect, the user interface can be a touch sensitive display, and, besides other things, may include selection of a container out of the one or more containers for which the corresponding heating device or the cooling device is to be activated, time at which the corresponding heating device or the cooling device is to be activated/deactivated and temperatures at which the selected container is to be maintained.

In an aspect, the control module and the battery pack can include a set of first pogo pins located in the region of the second aperture. The set of first pogo pins can enable electrical coupling of the battery pack with the control module for transfer of electric power from the battery pack to the lunch box through the control module.

In an aspect, the control module includes a power receiving port for receiving electric power from an external power source to meet the power requirement without depending on the battery pack.

In an aspect, the lunch box may further include one or more sets of second pogo pins provided between the one or more containers and the one or more containers to provide electrical connectivity between the containers and the one or more containers. The sets of second pogo pins can, besides other things, provide connectivity of the respective heating devices and the cooling devices with the control module through the respective set of second pogo pins.

In an aspect, each of the one or more containers can include a temperature sensor to sense its temperature. The temperature sensors can be operatively coupled to the control module through the respective set of second pogo pins.

In an aspect, the control module can be adapted to monitor the sensed temperature of the one or more containers, and stop heating or cooling of the containers when requirement of maintaining the defined temperature is met. Likewise, the control module can restart heating or cooling when the sensed temperature is found to deviate from the defined temperature.

In an aspect, the control module can be adapted to monitor a temperature time graph of the containers, which can be used to decide if the corresponding container is empty. If it is detected that a container is empty, the control module can stop controlling temperature of the corresponding container.

In an aspect, at least one of the one or more containers can includes a bowl with an electrically insulated heating element wound around the bowl. The heating element can work as the heating device, and can be electrically coupled to the control module through the respective set of second pogo pins to receive electric current for heating the food article stored in the corresponding container.

In an aspect, at least one of the one or more containers can include a bowl with at least one peltier thermoelectric module affixed to the bowl to work as a cooling device. The peltier thermoelectric module can be electrically coupled to the control module through the respective set of second pogo pins. When required, the control module can provide an electric current to the peltier thermoelectric module in a first direction for the peltier thermoelectric module to cool the food article stored therein.

In an aspect, the peltier thermoelectric module may also be used to heat the contents. For which, the control module can provide an electric current to the peltier thermoelectric module in a second direction, which is opposite the first direction. The peltier thermoelectric module, on receiving electric current from the control module in the second direction, shall work as the heating device for heating the food article stored in the bowl.

In an alternate implementation, the control module can comprise one or more extensions. The extensions can have a set of third pogo pins for electrical coupling with a corresponding temperature sensor provided in the top lid. When the control module is received through a first aperture in the top lid, the extensions rest over the top lid and the temperature sensors get operatively coupled to the control module to detect temperature of the respective containers.

An aspect of the present disclosure relates to a system for controlling temperature of food articles. The proposed system includes a computing device having wireless communication means; and a lunch box that is communicably coupled to the computing device over a network. In an aspect, the lunch box includes one or more containers, each of the containers configured to store a food article and provided with one or both of a heating device and a cooling device. In another aspect, coupling of the lunch box with the computing device enables the lunch box to receive a set of user defined inputs regarding one or more of activation/deactivation of the heating devices and the cooling devices pertaining to the one or more containers, time at which the heating devices and the cooling devices are to be activated/deactivated and temperatures at which the one or more containers are to be maintained.

In an aspect, the computing device can be a smart phone having an app to configure the lunch box to heat or cool the food articles stored in the one or more containers at desired time and to a desired temperature.

In an aspect, the lunch box can include a battery bank to meet power requirement of the lunch box.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A illustrates an exemplary image of the proposed lunch box, in accordance with an embodiment of the present disclosure.

FIG. 1B illustrates exemplary images of the lunch box in open condition, in accordance with an embodiment of the present disclosure.

FIG. 2 illustrates an exemplary diagrammatic representation of the lunch box, showing fitment of a control module in a first aperture in a top lid, in accordance with an embodiment of the present disclosure.

FIG. 3A illustrates an exemplary diagrammatic representations of the lunch box with details of a container, in accordance with an embodiment of the present disclosure.

FIG. 3B illustrates an exemplary diagrammatic representations of the lunch box with an alternate configuration of the containers, in accordance with an embodiment of the present disclosure.

FIG. 4A illustrates an exemplary diagrammatic representation of a container fitted with a temperature sensor and a peltier thermoelectric module, in accordance with an embodiment of the present disclosure.

FIG. 4B illustrates an exemplary diagrammatic representation of a container fitted with a temperature sensor and a heating element, in accordance with an embodiment of the present disclosure.

FIG. 5 illustrates an exemplary diagrammatic representation of the lunch box showing fitment of a battery pack over the top lid, in accordance with an embodiment of the present disclosure.

FIG. 6 illustrates an alternate configuration of the control module enabling direct measurement of temperature of the containers by the control module, in accordance with an embodiment of the present disclosure.

FIG. 7 illustrates an exemplary system diagram for the disclosed system for controlling temperature of food articles provided in the lunch box, in accordance with embodiments of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

Embodiments of the present invention may be provided as a computer program product, which may include a machine-readable storage medium tangibly embodying thereon instructions, which may be used to program a computer (or other electronic devices) to perform a process. The term “machine-readable storage medium” or “computer-readable storage medium” includes, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). A machine-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-program product may include code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a machine-readable medium. A processor(s) may perform the necessary tasks.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms as used herein. To the extent a term used in a claim is not defined, it should be given the broadest definition persons in the pertinent art have given that term as reflected in printed publications and issued patents at the time of filing.

Embodiments explained herein relate to a modular lunch box that can be used both as a conventional lunch box as well as a smart lunch box with remotely programmable heating and cooling functionality. The modular concept of the proposed lunch box is based on a control module that can be detachably received in an aperture of the lunch box, wherein coupling of the control module with the lunch box enables programmed cooling and heating functions. In another aspect, the control module also converts the lunch box to an IoT enabled smart lunch box such that the heating and cooling functions of the lunch box can be remotely configured and controlled through a computing device of its user.

In an embodiment, the modular lunch box includes one or more containers, each having independent either heating, or cooling, or both heating and cooling functions, and a top lid that covers and individually seals each of the containers. A control module of the lunch box, can be detachably attached to the lunch box, which on coupling, controls the heating and cooling functions for each of the containers. Thus, when the control module is not coupled to the lunch box, the lunch box can be used as a conventional lunch box without heating and cooling functionality. On the other hand, coupling of the control module with the lunch box enables the lunch box to be used as a lunch box having heating and cooling functionality.

In an embodiment, the control module can control heating and cooling functions to keep the contents of a container cool to prevent growth of microorganisms and thereby avoid spoilage of the stored food, and at predefined time set by the user, start heating the contents so that hot contents are available at a desired time. In alternate embodiments, there can be containers only to cool the contents, and other containers to only heat the contents, thereby providing flexibility depending on nature of food article.

In an embodiment, in order to remotely configure the lunch box using a computing device, such as a smart phone, the control module includes a wireless communication module to couple the lunch box with the computing device through a network. The coupling of the lunch box with the computing device enables the lunch box to receive a set of user defined inputs to regarding one or more of activation of the heating devices and the cooling devices pertaining to the one or more containers, time at which the heating devices and the cooling devices are to be activated and temperatures at which the one or more containers are to be maintained.

In an embodiment of the modular concept of the proposed lunch box, a battery pack can be removably positioned over the top lid of the lunch box, where it gets electrically coupled to the control module to meet power requirement of the lunch box for heating and cooling of food articles stored in the one or more container. In an embodiment, the coupling of the battery pack to the control module is through an aperture (referred to as second aperture), which provides both mechanical and electrical coupling between the two. Thus, the battery pack retains the heating and cooling functionality of the lunch box, when external power is not available, the disclosed lunch box includes a battery pack.

In alternate embodiment, when external power is available, the heating and cooling functionality of the lunch box can be run using the external power by connecting the external power source to a power receiving port provided on the control module.

In an embodiment, the control module can include a memory; and a processor. The processor may be coupled to the memory, and can execute a plurality of instructions stored in the memory. The processor may also be operatively coupled to the wireless module to receive the one or more user defined inputs and store them in the memory.

In an embodiment, to enable direct configuring of the lunch box the control module may comprise a user interface, which can be operatively coupled to the memory of the control module to store the one or more user defined inputs provided by the user through the interface.

In an aspect, each of the one or more containers can include a temperature sensor to sense its temperature. The temperature sensors can be operatively coupled to the control module for monitoring and maintaining temperature of the containers.

In an aspect, the control module can be adapted to monitor a temperature time graph of the containers, which can be used to decide if the corresponding container is empty. If it is detected that a container is empty, the control module can stop controlling temperature of the corresponding container.

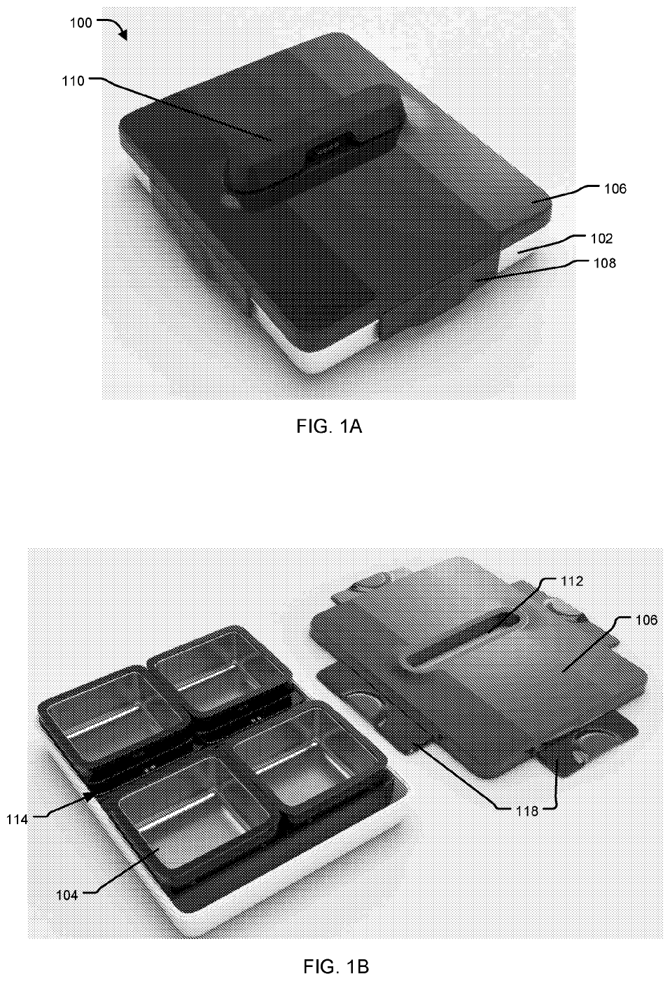

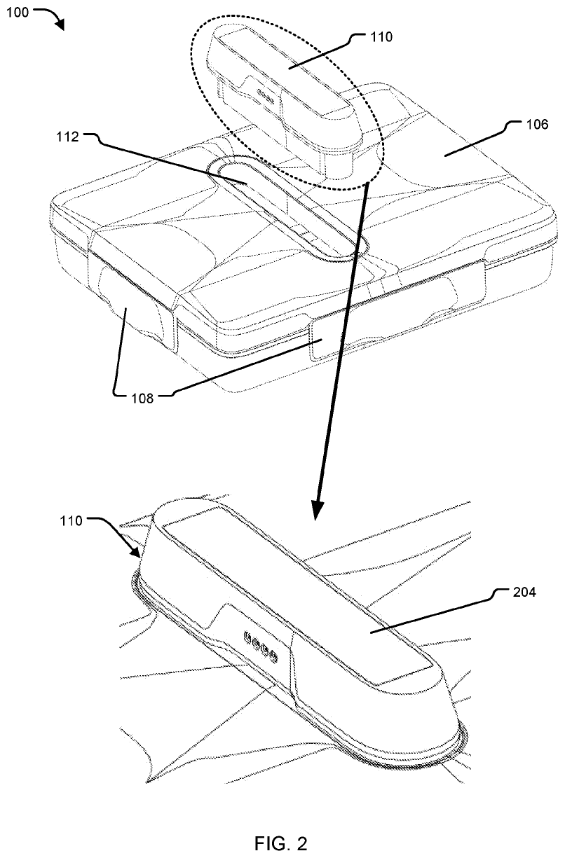

Referring to FIGS. 1A, 1B and 2, where exemplary photographic images and diagrammatic representations respectively of the proposed modular lunchbox are shown, the modular lunch box 100 can include a base 102, one or more containers 104 received within the base 102, which works as a housing to hold the one or more containers 104, and a top lid 106 that individually seals each of the containers 104. The top lid 106 can be secured over the base 102 through a plurality of clips 108. The modular lunch box 100 further includes a control module 110, which is received in an aperture, referred to a first aperture 112, in the top lid 106, as shown in FIGS. 1A, 1B and 2. Lower portion of the control module 110, on being received in the first aperture 112, is accommodated in a space 114 (refer to FIG. 1B) between the containers 104, and gets operatively coupled to the one or more containers 104 to control their heating and cooling, as would be described in subsequent paragraphs.

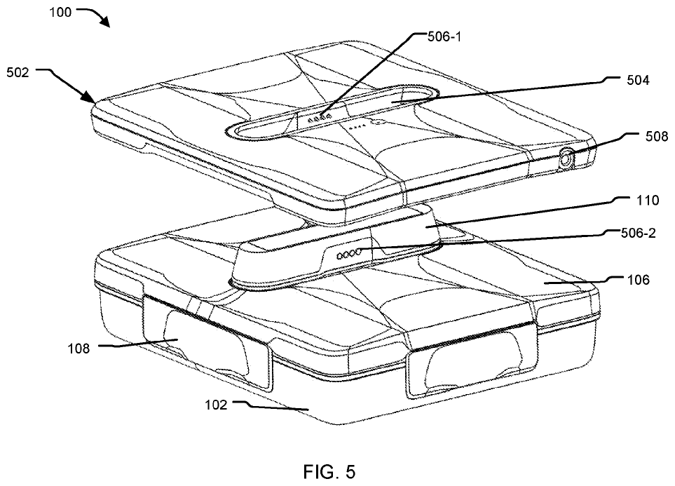

In an embodiment, detachable control module 110 makes the disclosed lunch box 100 modular in the sense that when the control module 110 is not coupled to the top lid 106, the modular lunch box 100 can be used as a conventional lunch box without any heating and cooling functionality, and without having to carry additional weight of control module 110 and a battery pack (not shown in these illustrations, refer to FIG. 5). On the other hand, coupling of the control module 110 with the top lid 106 enables programmed cooling and heating functions, using an external power source or the battery pack 502 (refer to FIG. 5), depending on whether external power is available or not.

In an embodiment, the control module 110 can include a memory and a processor. The processor may be coupled to the memory, and can execute a plurality of instructions stored in the memory. The stored instructions may pertain to monitoring the temperature of the containers, comparing the monitored temperature with a predefined temperature to decide if cooling or heating function corresponding to the respective containers are to be activated.

In an embodiment, the stored instructions in the control module 110 can also enable the control module 110 to monitor a temperature time graph of the one or more containers 104. Base on the monitoring, the stored instructions can enable the control module 110 to decide, if the corresponding container is empty. For example, if cooling or heating is too quick, it can be concluded that the container is empty. When it is found that the corresponding container is empty, the stored instructions can stop controlling temperature of the identified container so as to conserve power.

In an embodiment, the modular lunch box 100, whether coupled with the control module 110 or without the control module 110, is a portable lunchbox configured for storing food articles in one or more containers 104. When coupled with the control module, the modular lunch box 100 is an electric lunchbox and consumes electricity for heating or cooling of the food articles provided in the containers 104. In an embodiment, a temperature associated with each of the containers 104 can be selectively and independently controlled by the control module 110. In an example, depending on availability, the modular lunch box 100 can receive electricity from either a battery pack or an external power source. The modular lunch box 100 is also customizable with respect to the configuration of containers 104 meant for holding food articles.

In another embodiment, the control module 110, besides controlling heating and cooling functions of the one or more containers 104, also receives and stores user instructions in form of user defined parameters in respect of cooling and heating function of each of the one or more containers 104. The user defined inputs can be, for example, time of activation of the heating devices and the cooling devices pertaining to each of the one or more containers, and temperatures at which each of the one or more containers are to be maintained. Thus, with the user defined inputs being available with the control module 110, it can automatically start heating/cooling of the containers, each at the corresponding user defined time and maintain temperature of the individual containers at the corresponding user defined temperatures.

In an embodiment, the control module 110 includes a wireless communication module to enable connection, through a network, to a remote computing device of a user, so that user may provide the inputs without being physically present near the modular lunch box 100. The remote computing device can be a smart phone of the user, and can have an App to enable user to configure the modular lunch box 100 to enable heating and/or cooling as desired.

Alternatively, the control module 110 can be configured by the user through a user interface 204 (refer to FIG. 2). The interface 204 can be operatively coupled to the memory of the control module, and the inputs provided by the user through the interface 204 can get stored in the memory.

In an embodiment, the user interface 204 can be a touch sensitive display, and, besides other things, may include selection of a container out of the one or more containers 104 to which the inputs relate.

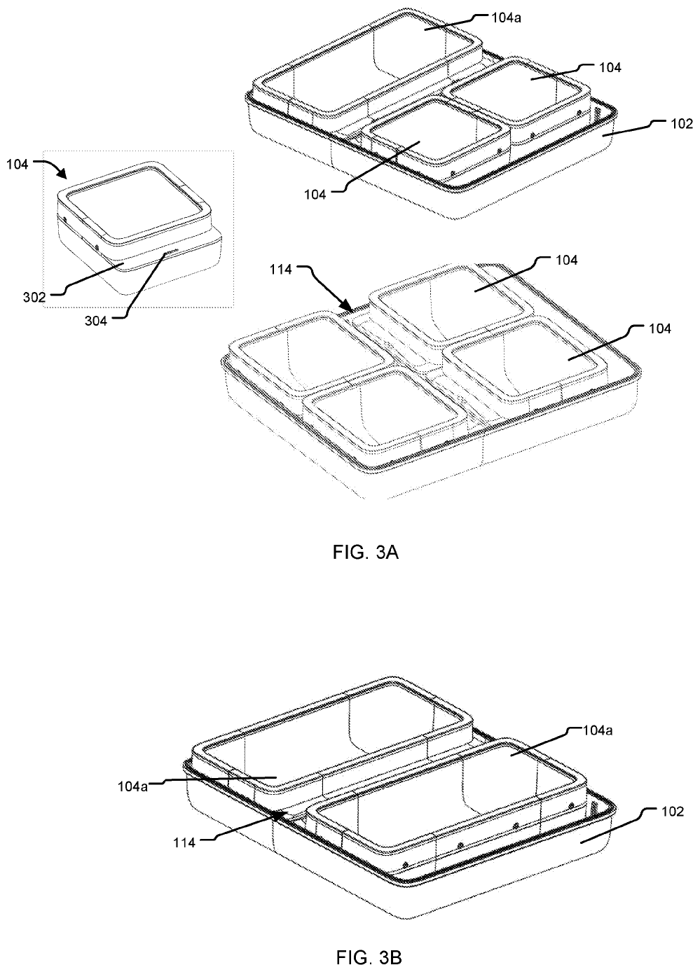

FIG. 3A illustrates an exemplary diagrammatic representations of the lunch box with details of a container 104, which as shown, includes a step portion 302. When the containers 104 are accommodated within the base 102, the step portions, such as step portion 302, of the containers provide a bottom surface of the space 114 where the lower portion of the control module 110 is accommodated. Thus a lower side of the control module 110 rests against the step portions 302 of the containers 104.

In an embodiment, a set of pogo pins, such as second pogo pins, are configured between the control module 110 and each of the containers to provide electrical connectivity between the containers 104 and the control module 110. Accordingly each of the containers 104 can have corresponding features 304 of the corresponding set of second pogo pins. As can be understood, there can be as many sets of the second pogo pins as the number of containers 104 for connectivity between the control module 110 and each of the containers 104.

Also shown in FIG. 3A are two different configurations of the containers 104 and 104a, wherein container 104 is a small container and container 104a is a larger container. Depending on potion of the food article, user may select a suitable container 104/104a.

Yet another configuration of the modular lunch box 100 is shown in FIG. 3B, where each of the one or more container is a larger container 104a. Each of the larger containers 104a can also have a step portion to form a space 114 for accommodating the control module 110, and for the control module 110 to rest against the step portion of the containers 104a for coupling through the corresponding set of second pogo pins.

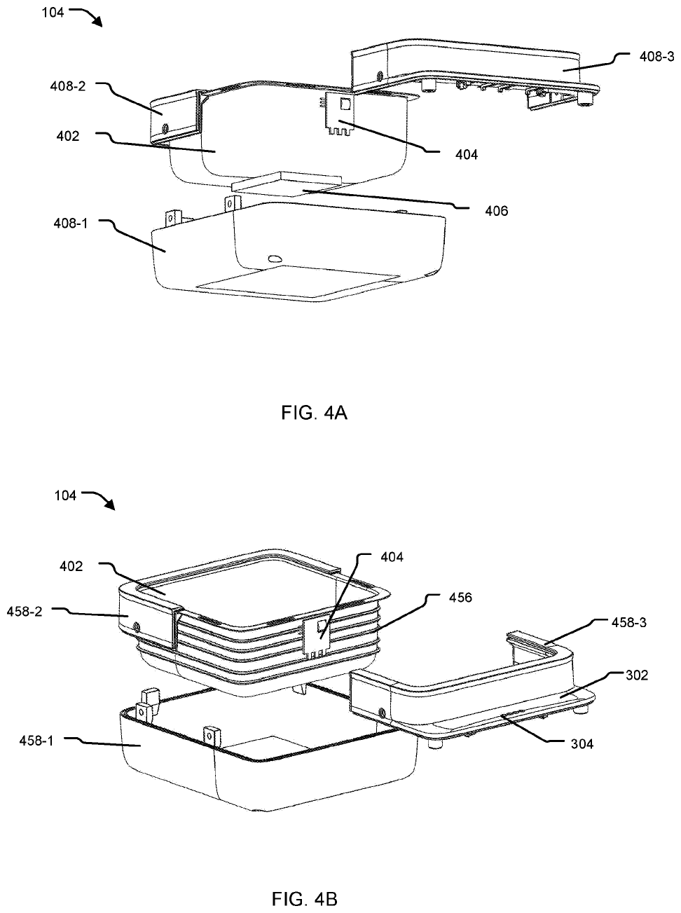

FIGS. 4A and 4B show constructional details of the containers 104 having a temperature sensor along with a peltier thermoelectric module or a heating element respectively. As shown, the container 104 can include a bowl 402 made of a thermally conducting material, such as a metal, and the temperature sensor 404 may be affixed to an outer surface of the bowl 402. The container may have a peltier thermoelectric module 406, as shown in FIG. 4A, or a heating element 456, as shown in FIG. 4B, in contact with the bowl 402.

In an embodiment, the heating device can be a heating element/wire 456 wound around the bowl 402 to heat the contents of the container 104. The heating element/wire 456 may include Stainless Steel (SS) or Nichrome wires. The heating element 456 can be an insulated heating element, such as by providing a thin layer of a thermally conducting, electrical insulating material between the resistor of the heating element 456 and the bowl 402. Alternatively, the container itself may be made of a thermally conducting, electrical insulating material, and the heating element/wire 456 may be directly wound around the bowl 402.

In an embodiment, the temperature sensor 404 and the peltier thermoelectric module 406 or the heating element 456, as the case may be, can be covered by an outer covering, such as one comprising upper left covering 408-2/459-2, an upper right covering 408-3/458-3 and a lower covering 408-1/458-1 (collectively referred to as outer covering 408/458). The outer covering 408/458 can include the step portion 302 and features related to engagement with the second pogo pins provided with the control module 110. Accordingly, the temperature sensor 404 and the peltier thermoelectric module 406 or the heating element 456, as the case may be, can be connected to the features of the second pogo pin 304 for their coupling to the control module 110. Thus, each container 104 is self-sufficient to enable monitoring of temperature of its contents and for heating and/or cooling based on supply of current from the control module 110 in accordance with user inputs.

In an embodiment, the outer covering 408/458 may insulate the respective containers 104, such that different temperatures among the containers 104 do not affect each other.

As is well known, peltier thermoelectric modules can, on supply of a current in a given direction (referred to a first direction), transfer heat from a first surface towards a second surface that is opposite the first surface. And when direction of the current is reversed, that is, the current is supplied in a second direction, which opposite the first direction, peltier thermoelectric modules transfer heat from the second first surface towards the first surface. Therefore, if the peltier thermoelectric module 406 is configured with its first surface resting against the bowl 402, it shall, on supply of a current in the first direction, cool the bowl 402. On the other hand, when the direction of current is reversed, it can heat the bowl 402. Therefore, a container 104 configured with a peltier thermoelectric module can cool as well as heat its contents. For example, the contents can be initially cooled to prevent growth of microorganisms and thereby avoid spoilage of the stored food, and at predefined time set by the user, the contents can be heated so that hot contents are available at a desired time. Alternatively, depending on nature of the food article stored in the container fitted with a peltier thermoelectric module, the contents can be only cooled, or only heated.

In an embodiment, it is possible to use heat extracted by a peltier thermoelectric module 406 from a container 104, which is being cooled, to heat contents of another container which needs heating. For this, the peltier thermoelectric module 406 may be configured such that the second surface of the peltier thermoelectric module 406 is thermally coupled to the container 104 that needs heating. This shall help in conserving power consumed towards heating and cooling of contents of the containers 104, making the proposed lunch box 100 energy efficient.

FIG. 5 shows fitment of a battery pack over the top lid 106 of the modular lunch box 100, when external power source is not available for heating/cooling of its contents. The battery pack 502 can be shaped to match shape of the top lid 106 of the lunch box 100, and can have an aperture, referred to as second aperture 504. When the battery pack 502 is positioned over the top lid 106, the second aperture 504 engages with a projected portion of the control module 110 to mechanically as well as electrically couple the battery pack 502 with the modular lunch box 100. Specifically, the engagement prevents sideways displacement of the battery pack 502 over the top lid 106.

In an embodiment, the electrical coupling between the battery pack 502 and the control module 110 can be through a set of pogo pins, referred to as set of second pogo pins, wherein the corresponding features 506-1 and 506-2 of the second pogo pins can be within the second aperture 504 and on a corresponding side face of the control module 110.

In an embodiment, the battery pack 502 can be a rechargeable battery pack and can include a charging port 508 for receiving charging current from an external power source.

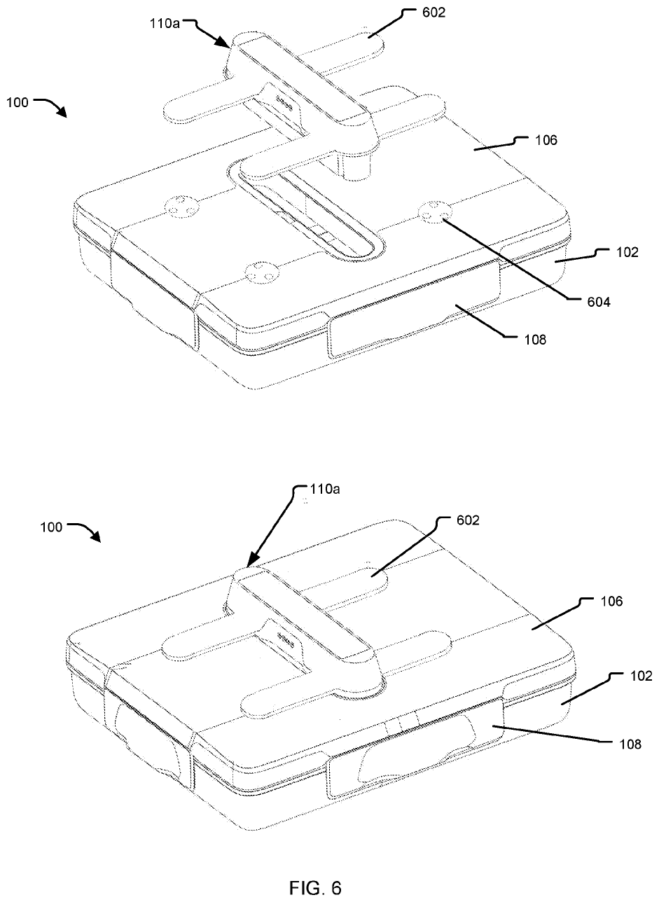

FIG. 6 illustrates an alternate configuration of the control module enabling direct measurement of temperature of the containers by the control module. As shown, the alternate control module 110a can have one or more extensions, such as extension 602. The extensions 602 can be configured with temperature sensor for direct measurement of temperatures of the one or more containers 104. The temperature sensors, such as temperature sensors 604 can be integrated with the top lid 106 so that, when the top lid 106 covers the containers 104, the temperature sensors 604 are above the containers 104 to directly sense the temperature of contents of the respective containers. The extensions 602 and the temperature sensors 604 can include pogo pins, referred to as sets of third pogo pins, to provide electrical connectivity between the control module 110a and the respective temperature sensors 604.

Accordingly, based on the aforementioned specification, the modular lunch box 100 can be used in different modes. The different modes can include a first mode as a conventional lunch box without any heating and cooling functions. In this mode the user can simply fill the food articles in the containers 104 and close the top lid 106 using the clips 108. The control module 110 shall not be coupled to the lunch box, and shall not require any power input in form of battery pack 502 or external power source.

In a second mode, the modular lunch box 100 can work as an electric lunch box with power supply from an external source. In this mode, after filling the containers 104 and closing the top lid 106, the user can couple the control module 110 to the lunch box through the first aperture 112, and connect the control module 110 to an external power source through an AC to DC adapter. This mode can be used when heating/cooling is required and an external power source is available.

In a second mode, the modular lunch box 100 can work as an electric lunch box with power supply from a battery pack, such as battery pack 502. In this mode, after filling the containers 104, closing the top lid 106, and coupling the control module 110 to the lunch box through the first aperture 112, the user can place the battery pack 502 over the top lid 106 through the second aperture 504. The battery pack 502 shall electrically couple to the control module 110 to work as a power source. This mode can be used when heating/cooling is required, and external power source is not available, such as when traveling or at a remote location.

In an embodiment, in the second and third modes of operation, the modular lunch box 100 can be configured for cooling and/or heating the containers 104 at user defined times through the control module 110, either using the interface 204 provided on the control module 110, or remotely using a computing device, such as a smart phone of the user.

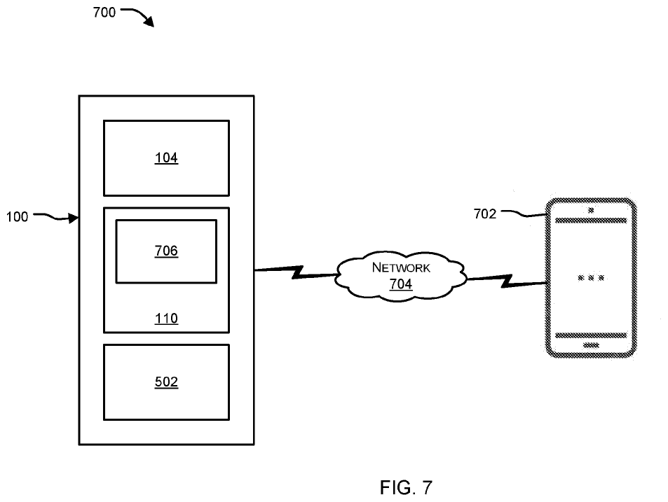

FIG. 7 shows a system diagram for the proposed system for controlling temperature of food articles. As shown, the system 700 for controlling temperature of food articles can comprise a computing device 702 having wireless communication means, and the disclosed modular lunch box 100. The computing device 702 may be a smart phone or a like device belonging to a user associated with the modular lunch box 100. The lunch box can be communicably coupled to the computing device 702 over a network 704. In an aspect, the modular lunch box 100 includes one or more containers 104, each of the containers 104 configured to store a food article and provided with one or both of a heating device and a cooling device.

In an aspect, the coupling of the modular lunch box 100 with the computing device 702 enables the modular lunch box 100 to remotely receive a set of user defined inputs regarding one or more of activation of the heating devices and the cooling devices pertaining to the one or more containers 104, time at which the heating devices and the cooling devices pertaining to the one or more containers 104 are to be activated and temperatures at which the one or more containers 104 are to be maintained.

In an embodiment, the user/computing device 702 may be communicably coupled to a wireless communication module 706 of the control module 110 of the modular lunch box 100. In an example, the user device 702 may include an application that may be configured to control an operation of the modular lunch box 100 through the control module 110. In an example, the user device 702 may allow the user to operate the modular lunch box 100, and the operation may include tuning the modular lunch box 100 ON/OFF, setting a time of heating and/or cooling, setting a temperature, selectively operating the containers 104, operating the modular lunch box 100 in an automatic or semi-automatic mode, etc. In an embodiment, selective operation of the containers 104 may include simultaneous heating and cooling of the different containers 104, first cooling and thereafter heating of one or more containers 104 at time defined for each of the containers, only heating or only cooling of the containers 104, or selectively powering a particular container 104 and keeping the other containers as dormant, etc.

Although the proposed system 700 has been elaborated as above to include all the main parts, it is completely possible that actual implementations may include only a part of the proposed modules/engines or a combination of those or a division of those in various combinations across multiple devices that can be operatively coupled with each other, including in the cloud. Further the modules/engines can be configured in any sequence to achieve objectives elaborated. Also, it can be appreciated that proposed system 700 can be configured in a computing device or across a plurality of computing devices operatively connected with each other, wherein the computing devices can be any of a computer, a laptop, a smart phone, an Internet enabled mobile device and the like. All such modifications and embodiments are completely within the scope of the present disclosure.

In an implementation, the proposed system 700, discussed above, can be embedded with/incorporated with one or more Internet of Things (IoT) devices. In a typical network architecture of the present disclosure can include a plurality of network devices such as transmitter, receivers, and/or transceivers that may include one or more IoT devices. An IOT device consisting of a Gateway (any Wi-Fi SOC) coupled with the modular lunch box 100 and the user device 702. Each such device has a LED display and QR code (or NFC, RFID) associated with it.

As used herein, the IoT devices can be a device that includes sensing and/or control functionality as well as a WiFi™ transceiver radio or interface, a Bluetooth™ transceiver radio or interface, a Zigbee™ transceiver radio or interface, an Ultra-Wideband (UWB) transceiver radio or interface, a Wi-Fi-Direct transceiver radio or interface, a Bluetooth™ Low Energy (BLE) transceiver radio or interface, and/or any other wireless network transceiver radio or interface that allows the IoT device to communicate with a wide area network and with one or more other devices. In some embodiments, an IoT device does not include a cellular network transceiver radio or interface, and thus may not be configured to directly communicate with a cellular network. In some embodiments, an IoT device may include a cellular transceiver radio, and may be configured to communicate with a cellular network using the cellular network transceiver radio.

A user may communicate with the network devices using an access device that may include any human-to-machine interface with network connection capability that allows access to a network. For example, the access device may include a stand-alone interface (e.g., a cellular telephone, a smartphone, a home computer, a laptop computer, a tablet, a personal digital assistant (PDA), a computing device, a wearable device such as a smart watch, a wall panel, a keypad, or the like), an interface that is built into an appliance or other device e.g., a television, a refrigerator, a security system, a game console, a browser, or the like), a speech or gesture interface (e.g., a Kinect™ sensor, a Wiimote™, or the like), an IoT device interface (e.g., an Internet enabled device such as a wall switch, a control interface, or other suitable interface), or the like. In some embodiments, the access device may include a cellular or other broadband network transceiver radio or interface, and may be configured to communicate with a cellular or other broadband network using the cellular or broadband network transceiver radio. In some embodiments, the access device may not include a cellular network transceiver radio or interface.

User may interact with the network devices using an application, a web browser, a proprietary program, or any other program executed and operated by the access device. In some embodiments, the access device may communicate directly with the network devices (e.g., communication signal). For example, the access device may communicate directly with network devices using Zigbee™ signals, Bluetooth™ signals, WiFi™ signals, infrared (IR) signals, UWB signals, WiFi-Direct signals, BLE signals, sound frequency signals, or the like. In some embodiments, the access device may communicate with the network devices via the gateways and/or a cloud network.

Local area network may include a wireless network, a wired network, or a combination of a wired and wireless network. A wireless network may include any wireless interface or combination of wireless interfaces (e.g., Zigbee™, Bluetooth™, WiFi™ IR, UWB, WiFi-Direct, BLE, cellular, Long-Term Evolution (LTE), WiMax™, or the like). A wired network may include any wired interface (e.g., fiber, Ethernet, powerline, Ethernet over coaxial cable, digital signal line (DSL, or the like). The wired and/or wireless networks may be implemented using various routers, access points, bridges, gateways, or the like, to connect devices in the local area network. For example, the local area network may include gateway and gateway. Gateway can provide communication capabilities to network devices and/or access device via radio signals in order to provide communication, location, and/or other services to the devices. The gateway is directly connected to the external network and may provide other gateways and devices in the local area network with access to the external network. The gateway may be designated as a primary gateway.

The network access provided by gateway may be of any type of network familiar to those skilled in the art that can support data communications using any of a variety of commercially-available protocols. For example, gateways may provide wireless communication capabilities for the local area network 100 using particular communications protocols, such as WiFi™ (e.g., IEEE 802.11 family standards, or other wireless communication technologies, or any combination thereof). Using the communications protocol(s), the gateways may provide radio frequencies on which wireless enabled devices in the local area network can communicate. A gateway may also be referred to as a base station, an access point, Node B, Evolved Node B (eNodeB), access point base station, a Femtocell, home base station, home Node B, home eNodeB, or the like.

Gateways may include a router, a modem, a range extending device, and/or any other device that provides network access among one or more computing devices and/or external networks. For example, gateway may include a router or access point or a range extending device. Examples of range extending devices may include a wireless range extender, a wireless repeater, or the like.

A router gateway may include access point and router functionality, and may further include an Ethernet switch and/or a modem. For example, a router gateway may receive and forward data packets among different networks. When a data packet is received, the router gateway may read identification information (e.g., a media access control (MAC) address) in the packet to determine the intended destination for the packet. The router gateway may then access information in a routing table or routing policy, and may direct the packet to the next network or device in the transmission path of the packet. The data packet may be forwarded from one gateway to another through the computer networks until the packet is received at the intended destination.

As in a typical network, architecture of the present disclosure can include a plurality of network devices such as transmitter, receivers, and/or transceivers that may include one or more Internet of Things (TOT) devices. As used herein, an IOT devices can be a device that includes sensing and/or control functionality as well as a Wi-Fi transceiver radio or interface, a Bluetooth transceiver radio or interface, a Zigbee transceiver radio or interface, an Ultra-Wideband (UWB) transceiver radio or interface, a Wi-Fi Direct transceiver radio or interface, a Bluetooth Low Energy (BLE) transceiver radio or interface, and/or any other wireless network transceiver radio or interface that allows the IOT device to communicate with a wide area network and with one or more other devices. In some embodiments, an IOT device may include a cellular transceiver radio, and may be configured to communicate with a cellular network using the cellular network transceiver radio.

Embodiments of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable people having ordinary skill in the art to make and use the invention when combined with information and knowledge available to the person having ordinary skill in the art.

### ADVANTAGES OF THE PRESENT DISCLOSURE

The present disclosure provides a modular lunch box that can be used both as a conventional lunch box as well as a smart lunch box with heating and cooling functionality.

The present disclosure provides an improved lunch box that enables selective cooling or heating of stored food.

The present disclosure provides a lunch box that does not depend on external power source for heating and cooling functions.

The present disclosure provides a lunch box that allows selective cooling or heating of stored food to desired temperatures, at predefined times without physical presence of user.

The present disclosure provides a lunch box that can be controlled remotely through a computing device.

The present disclosure provides a lunch box that can simultaneously provide heating of certain food articles and cooling of other food articles.

The present disclosure provides a lunch box with customizable food containers.

I claim:

1. A modular lunch box comprising:
a base defining an housing to receive one or more containers, each of the containers configured to store a food article and provided with one or both of a heating device and a cooling device;
a top lid configured to be removably received on the base to cover and individually seal the one or more containers received within the base; and
a control module detachably received through a first aperture in the top lid such that on being received through the first aperture, the control module rests against a step portion of the one or more containers and gets operatively coupled to the heating devices and the cooling devices to control temperatures of the one or more containers through the heating devices and the cooling devices;
wherein coupling of the control module with the top lid enables the lunch box to be used as a lunch box having heating and cooling functionality, and wherein when the control module is not coupled with the top lid the lunch box is used as a conventional lunch box.

2. The modular lunch box as claimed in claim 1, wherein the control module includes a wireless communication module to receive user defined inputs regarding one or more of activation of the heating devices and the cooling devices pertaining to the one or more containers, time at which the heating devices and the cooling devices are to be activated and deactivated, and temperatures at which the one or more containers are to be maintained.

3. The modular lunch box as claimed in claim 2, comprising a battery pack adapted to be positioned over the top lid such that when positioned over the top lid, the battery pack gets electrically coupled to the control module to meet power requirement of the lunch box for heating and cooling of food articles stored in the one or more container.

4. The modular lunch box as claimed in claim 3, wherein the battery pack includes a second aperture, and the battery pack when positioned over the top lid, gets mechanically coupled to the control module through the second aperture to prevent sideways displacement of the battery pack.

5. The modular lunch box as claimed in claim 1, wherein the control module comprises:
a memory; and
a processor coupled to the memory, and configured to execute a plurality of instructions stored in the memory;
wherein the processor is operatively coupled to the wireless module to receive the one or more user defined inputs and store them in the memory.

6. The modular lunch box as claimed in claim 5, wherein the control module comprises a user interface operatively coupled to the memory to store the one or more user defined inputs provided by the user through the interface.

7. The modular lunch box as claimed in claim 6, wherein the user interface is enabled by a touch sensitive display and includes selection of a container out of the one or more containers for which the corresponding heating device or the cooling device is to be activated, time at which the corresponding heating device or the cooling device is to be activated and temperatures at which the selected container is to be maintained.

8. The modular lunch box as claimed in claim 4, wherein the control module and the battery pack include a set of first pogo pins located in the region of the second aperture for the battery pack to get electrically coupled to the control module for transfer of electric power from the battery pack to the lunch box.

9. The modular lunch box as claimed in claim 1, wherein the control module includes a power receiving port for receiving electric power from an external power source.

10. The modular lunch box as claimed in claim 1, wherein the lunch box includes one or more sets of second pogo pins provided between the one or more containers and the control module to provide electric connectivity between the control module and the one or more containers, wherein the electrical connectivity includes connectivity of the respective heating devices and the cooling devices with the control module through the respective set of second pogo pins.

11. The modular lunch box as claimed in claim 10, wherein each of the one or more containers includes a temperature sensor to sense temperature of the respective containers, the temperature sensors being operatively coupled to the control module through the respective set of second pogo pins.

12. The modular lunch box as claimed in claim 10, wherein the control module is adapted to monitor the sensed temperature of the one or more containers, and stop heating or cooling of the one or more containers when requirement of maintaining the defined temperature is met, and restart heating or cooling when the sensed temperature is found to deviate from the defined temperature.

13. The modular lunch box as claimed in claim 10, wherein the control module is adapted to monitor a temperature time graph of the one or more containers, and decide, based on the temperature time graph, if the corresponding container is empty, and thereafter stop controlling temperature of the corresponding container.

14. The modular lunch box as claimed in claim 10, wherein at least one of the one or more containers includes a bowl with a heating element wound around the bowl to work as the heating device, the heating element being electrically coupled to the control module through the respective set of second pogo pins to receive electric current for heating the food article stored therein.

15. The modular lunch box as claimed in claim 10, wherein at least one of the one or more containers includes a bowl with at least one peltier thermoelectric module affixed to the bowl to work as a cooling device, the peltier thermoelectric module being electrically coupled to the control module through the respective set of second pogo pins, and wherein the control module is adapted to provide an electric current to the peltier thermoelectric module in a first direction for the peltier thermoelectric module to cool the food article stored therein.

16. The modular lunch box as claimed in claim 15, wherein the control module is adapted to provide an electric current to the peltier thermoelectric module in a second direction, which is opposite the first direction, and wherein the peltier thermoelectric module, on receiving electric current from the control module in the second direction, works as the heating device for heating the food article stored in the bowl.

17. The modular lunch box as claimed in claim 1, wherein the control module comprises one or more extensions, each of the one or more extensions having a set of third pogo pins for electrical coupling with a corresponding temperature sensor provided in the top lid; and wherein, when the control module is received through a first aperture in the top lid, the one or more extensions rest over the top lid the temperature sensors to get operatively coupled to the control module to detect temperature of the respective containers.

18. A system for controlling temperature of food articles, said system comprising:
a computing device having wireless communication means; and
a lunch box being communicably coupled to the computing device over a network, wherein the lunch box includes one or more containers, each of the containers configured to store a food article and provided with one or both of a heating device and a cooling device:
wherein to coupling of the lunch box with the computing device enables the lunch box to receive a set of user defined inputs regarding one or more of activation of the heating devices and the cooling devices pertaining to the one or more containers, time at which the heating devices and the cooling devices are to be activated and temperatures at which the one or more containers are to be maintained.

19. The system as claimed in claim 18, wherein the computing device is a smart phone having an app to configure the lunch box to heat or cool the food articles stored in the one or more containers at desired time and to a desired temperature.

20. The system as claimed in claim 18, wherein the lunch box includes a battery pack to meet power requirement of the lunch box.
